(19) United States
(12) Patent Application Publication
(10) Pub. No.: US 2026/0193566 A1
(43) Pub. Date: Jul. 9, 2026

(54) PARTICULATE DETERGENT COMPOSITION

(71) Applicant: THE PROCTER & GAMBLE COMPANY, Cincinnati, OH (US)

(72) Inventors: Dan XU, Beijing (CN); Benjamin Mark HADDRELL, Newcastle upon Tyne (GB); Ying WANG, Beijing (CN)

(21) Appl. No.: 19/440,943

(22) Filed: Jan. 6, 2026

(30) Foreign Application Priority Data
Jan. 6, 2025 (WO) PCT/CN2025/070703

(51) Int. Cl. C11D 1/22; C11D 1/14; C11D 1/90; C11D 3/04; C11D 3/10; C11D 3/12

(52) U.S. Cl. CPC C11D 1/22; C11D 1/146; C11D 1/90; C11D 3/046; C11D 3/10; C11D 3/1246; C11D 3/128

(57) ABSTRACT

A particulate detergent composition comprising a plurality of detergent granules, wherein said composition comprises (a) from 10 wt % to 60 wt %, by weight of the composition, of a major surfactant, and (b) from 0.02 wt % to 0.45 wt %, by weight of the composition, of a co-surfactant.

### FIELD OF THE INVENTION

The present invention relates to a particulate detergent composition comprising a plurality of detergent granules, wherein said composition comprises a major surfactant and a co-surfactant which is a betaine or a sultaine.

### BACKGROUND OF THE INVENTION

Granular detergent compositions of today are incorporating larger amounts and greater varieties of cleaning actives, which enable a myriad of benefits including superior cleaning, sensorial, environmental sustainability, convenience, and efficiency.

Recently, sustainability is becoming more and more important worldwide in all industries including detergent products. As such, in order to reduce energy consumption during the manufacturing of cleaning actives, there is a need for detergent compositions capable of providing desirable cleaning performance with a reduced total amount of actives, e.g. surfactants.

Betaine or sultaine are widely used in consumer products such as shampoos and conditioners, to provide suds-boosting and creamy suds benefit. However, they are mainly used in the products of hair care and personal care rather than laundry detergent products, probably due to insufficient cleaning performance in washing fabrics. On the other hand, even in a few limited examples of laundry detergent products containing betaine, it is present at a relatively high level.

### SUMMARY OF THE INVENTION

The present invention has discovered, surprisingly and unexpectedly, that when adding a relatively low level of betaine or sultaine as a co-surfactant in a particulate detergent composition, it can enable a reduced total surfactant content with a parity cleaning performance.

In one aspect, the present invention relates to a particulate detergent composition comprising a plurality of detergent granules, wherein said composition comprises:
(a) from 10 wt % to 60 wt %, by weight of the composition, of a major surfactant, and
(b) from 0.02 wt % to 0.45 wt %, by weight of the composition, of a co-surfactant,
wherein said major surfactant is selected from the group consisting of a C₁₀-C₂₀ linear or branched alkylalkoxylated sulfate (AAS) surfactant; a C₆-C₂₀ linear or branched unalkoxylated alkyl sulfate (AS) surfactant; a C₁₀-C₂₀ linear alkyl benzene sulphonate (LAS) surfactant; a methyl ester fatty acid sulphonate (MES) surfactant; alkyl alkoxylated alcohols and combinations thereof,
wherein said co-surfactant is a betaine or a sultaine,
wherein the weight ratio of said major surfactant to said co-surfactant ranges from 20:1 to 2500:1.

In some embodiments, the major surfactant comprises C₁₀-C₁₈ linear or branched unalkoxylated alkyl sulfate (AS) surfactant and/or a C₁₂-C₁₈ linear alkyl benzene sulphonate (LAS) surfactant. Preferably, the major surfactant comprises C₁₀-C₁₈ linear or branched unalkoxylated alkyl sulfate (AS) surfactant and a C₁₂-C₁₈ linear alkyl benzene sulphonate (LAS) surfactant.

In some embodiments, the co-surfactant is selected from the group consisting of: almondamidopropyl betaine, apricotamidopropyl betaine, avocadamidopropyl betaine, babassuamidopropyl betaine, behenamidopropyl betaine, canolamidopropyl betaine, capryl/capramidopropyl betaine, cocoamidopropyl betaine, coco/oleamidopropyl betaine, coco/sunfloweramidopropyl betaine, cupuassuamidopropyl betaine, isostearamidopropyl betaine, lauramidopropyl betaine, meadowfoamamidopropyl betaine, milkamidopropyl betaine, minkamidopropyl betaine, myristamidopropyl betaine, oatamidopropyl betaine, oleamidopropyl betaine, olivamidopropyl betaine, palmamidopropyl betaine, palmitamidopropyl betaine, palm kernelamidopropyl betaine, ricinoleamidopropyl betaine, sesamidopropyl betaine, shea butteramidopropyl betaine, soyamidopropyl betaine, stearamidopropyl betaine, tallowamidopropyl betaine, undecyleneamidopropyl betaine, wheat germamidopropyl betaine, cocamidopropyl hydroxysultaine (CAPHS), lauramidopropyl hydroxysultaine (LAPHS), oleamidopropyl hydroxysultaine (OAPHS), tallowamidopropyl hydroxysultaine (TAPHS), and combinations thereof. Preferably, the co-surfactant is selected from the group consisting of cocoamidopropyl betaine, lauramidopropyl betaine, oleamidopropyl betaine, tallowamidopropyl betaine, cocamidopropyl hydroxysultaine, and combinations thereof. More preferably, the co-surfactant is selected from cocoamidopropyl betaine, lauramidopropyl betaine, or a combination thereof.

In some embodiments, the major surfactant is present at a level of from 15 wt % to 50 wt %, preferably from 20 wt % to 40 wt %, for example 20 wt %, 25 wt %, 30 wt %, 35 wt %, 40 wt %, 45 wt %, 50 wt %, or any ranges therebetween, by total weight of said particulate detergent composition, and/or wherein said co-surfactant is present at a level of from 0.03 wt % to 0.4 wt %, preferably from 0.1 wt % to 0.35 wt %, for example 0.03 wt %, 0.05 wt %, 0.1 wt %, 0.2 wt %, 0.25 wt %, 0.3 wt %, 0.35 wt %, 0.4 wt %, 0.45 wt %, or any ranges therebetween, by total weight of said particulate detergent composition, and/or wherein the weight ratio of said major surfactant to said co-surfactant ranges from 25:1 to 2000:1, preferably from 30:1 to 1000:1, for example 30:1, 40:1, 50:1, 60:1, 70:1, 80:1, 90:1, 100:1, 120:1, 150:1, 170:1, 200:1, 300:1, 500:1, 1000:1, 2000:1 or any ranges therebetween.

In some embodiments, the composition further comprises one or more filler salts, preferably sodium sulfate and/or sodium chloride. Preferably, the content of filler salts ranges from 1% to 85%, preferably from 5% to 75%, more preferably from 10% to 65%, most preferably from 15% to 60%, by total weight of said particulate detergent composition.

In some embodiments, the composition further comprises alkali metal carbonate. Preferably, the content of alkali metal carbonate ranges from 1% to 85%, preferably from 5% to 75%, more preferably from 10% to 65%, most preferably from 15% to 60%, by total weight of said particulate detergent composition.

In some embodiments, the composition further comprises one or more ingredients selected from the group consisting of polymers, silicones, perfumes, nonionic surfactants, and combinations thereof; and wherein preferably each of said detergent granules further comprises a mixture of perfume(s) and nonionic surfactant(s).

In some embodiments, the total surfactant content in the particulate detergent composition is from 10% to 80%, preferably from 12% to 70%, more preferably from 14% to 65%, most preferably from 16% to 60%, by weight of the composition.

In some embodiments, the composition comprises:
(a) from 15 wt % to 20 wt %, by weight of the composition, of LAS; and/or
(b) from 4 wt % to 8 wt %, by weight of the composition, of AS; and/or
(c) from 0.05 wt % to 0.35 wt %, by weight of the composition, of cocoamidopropyl betaine; and/or
(d) from 0 wt % to 5 wt %, by weight of the composition, of zeolite builder; and/or
(e) from 5 wt % to 40 wt %, by weight of the composition, of sodium carbonate; and/or
(f) from 5 wt % to 40 wt %, by weight of the composition, of sodium sulfate; and/or
(g) from 0 wt % to 5 wt %, by weight of the composition, of silicate; and/or
(h) from 0 wt % to 5 wt % by weight of the composition, of a brightener.

In some embodiments, said detergent composition is in a form of an agglomerate, a spray-dried powder, and/or an extruded powder.

In some embodiments, said detergent composition is a laundry detergent composition.

In another aspect, the present invention relates to a method of making detergent granules, wherein the detergent granules comprise: a major surfactant; and a co-surfactant, wherein said major surfactant is selected from the group consisting of a C₁₀-C₂₀ linear or branched alkylalkoxylated sulfate (AAS) surfactant; a C₆-C₂₀ linear or branched unalkoxylated alkyl sulfate (AS) surfactant; a C₁₀-C₂₀ linear alkyl benzene sulphonate (LAS) surfactant; a methyl ester fatty acid sulphonate (MES) surfactant; alkyl alkoxylated alcohols and any combinations thereof, wherein said co-surfactant is a betaine or a sultaine, wherein the weight ratio of said major surfactant to said co-surfactant ranges from 20:1 to 2500:1, wherein the method comprises the steps in sequence: 1) preheating a paste comprising the major surfactant at 45~55° C., 2) adding the co-surfactant into the paste at 45~60° C. to form a mixed paste, and 3) drying the mixed paste to form the detergent granules.

In still another aspect, the present invention relates to the use of the above-mentioned detergent composition for washing fabrics.

It is an advantage that the present invention provides a reduced total surfactant content together with parity cleaning performance. Said detergent composition can providing comparative or even superior cleaning performance compared with detergent composition containing an increased level of major surfactant without betaine.

These and other aspects of the present invention will become more apparent upon reading the following detailed description of the invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

As used herein, the term “granule” or “particle” refers to a solid matter of minute quantity, such as a powder, granule, encapsulate, microcapsule, and/or prill. The granules or particles of the present invention can be spheres, rods, plates, tubes, squares, rectangles, discs, stars or flakes of regular or irregular shapes, but they are non-fibrous. The granules or particles of the present invention may have a median particle size of about 2000 μm or less, as measured according to the Median Particle Size Test described herein. Preferably, the particles of the present invention have a median particle size ranging from about 1 μm to about 2000 μm, more preferably from about 10 μm to about 1800 μm, still more preferably from about 50 μm to about 1700 μm, still more preferably from about 100 μm to about 1500 μm, still more preferably from about 250 μm to about 1000 μm, most preferably from about 300 μm to about 800 μm, as measured according to the Median Particle Size Test described herein.

As used herein, the term “detergent granule” refers to particles containing one or more detersive actives, including but not limited to surfactants, bleaching agents, enzymes, polymers, chelants, and combinations thereof.

As used herein, the term “cleaning composition” includes, unless otherwise indicated, granular or powder-form all-purpose or “heavy-duty” washing agents, especially cleaning detergents, for fabrics, as well as cleaning auxiliaries such as bleach, rinse aids, additives, or pre-treat types; hand dishwashing agents or light duty dishwashing agents, especially those of the high-foaming type; machine dishwashing agents; mouthwashes, denture cleaners, car or carpet shampoos, bathroom cleaners; hair shampoos and hair-rinses; shower gels and foam baths and metal cleaners; as well as cleaning auxiliaries such as bleach additives or pre-treat types. In one preferred aspect, the cleaning composition is a solid laundry detergent composition, and more preferably a free-flowing particulate laundry detergent composition (i.e., a granular laundry detergent product).

As used herein, the term “major surfactant” refers to a surfactant that is present in a composition at an amount that is greater than any other surfactant contained by such composition.

As used herein, the term “Median Particle Size” refers to the mid-point of the distribution of the particle sizes of the detergent granule, as measured by the Sieve Test as disclosed herein.

As used herein, the term “aspect ratio” refers to the ratio of the largest diameter of an article over the smallest diameter of such article orthogonal to the largest diameter.

As used herein, the term “water-soluble” refers to a solubility of more than about 25 grams per liter (g/L) of deionized water measured at 20° C. and under the atmospheric pressure.

As used herein, the terms “consisting essentially of” means that the composition contains less than about 1%, preferably less than about 0.5%, of ingredients other than those listed.

Further, the terms “essentially free of,” “substantially free of” or “substantially free from” means that the indicated material is present in the amount of from 0 wt % to about 0.5 wt %, or preferably from 0 wt % to about 0.1 wt %, or more preferably from 0 wt % to about 0.01 wt %, and most preferably it is not present at analytically detectable levels. The term “substantially pure” or “essentially pure” means that the indicated material is present in the amount of from about 99.5 wt % to about 100 wt %, preferably from about 99.9 wt % to about 100 wt %, and more preferably from 99.99 wt % to about 100 wt %, and most preferably all other materials are present only as impurities below analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

### Method of Making Detergent Granules

The present invention relates to a method of making detergent granules, wherein the method comprises the steps in sequence:
A1) mixing the major surfactant and the co-surfactant to form a mixed paste, and
A2) drying the mixed paste to form the detergent granules, or
B1) drying the major surfactant to form major surfactant particles and drying the co-surfactant to form co-surfactant particles, respectively, and
B2) mixing the major surfactant particles and the co-surfactant particles to form the detergent granules.

Particularly, the present invention relates to a method of making detergent granules, wherein the detergent granules comprise: (i) a major surfactant which is selected from the group consisting of a C₁₀-C₂₀ linear or branched alkylalkoxylated sulfate (AAS) surfactant; a C₆-C₂₀ linear or branched unalkoxylated alkyl sulfate (AS) surfactant; a C₁₀-C₂₀ linear alkyl benzene sulphonate (LAS) surfactant; a methyl ester fatty acid sulphonate surfactant; (ii) a co-surfactant which is a betaine or sultaine; and (iii) a water-soluble inorganic salt. An exemplary making method comprises the steps in sequence: first, preheating the major surfactant at about 50~80° C., secondly, adding water soluble inorganic salt into the preheated major surfactant with agitation at 50~80° C. to form a mixture, and thirdly, adding the co-surfactant into the mixture at 50~80° C. to form a mixed paste, and finally, drying the mixed paste to form the detergent granules.

In another example, the making method comprising the steps of (a) providing a mixture of the co-surfactant with the water-soluble inorganic salt, (b) preheating the major surfactant at 50~80° C., and then (c) adding the mixture from the step (a) into the preheated major surfactant in step (b) with agitation at 60~75° C. to form a mixed paste, and (d) drying the mixed pasted formed in the step (c) to form the detergent granules. The premix step (a) can be conducted before the preheating step (b), or after the preheating step (b), or the premix step (a) and preheating step (b) can be conducted at the same time. The premix step (a) can be conducted at ambient temperature or an increased temperature of 30~80° C.

### Major Surfactant

The detergent composition according to the present disclosure may comprise a major surfactant. The major surfactant content in the finished product, i.e., the solid detergent composition, may range from 15% to 60%, preferably from 15 wt % to 50 wt %, more preferably from 20 wt % to 40 wt %, for example 20 wt %, 25 wt %, 30 wt %, 35 wt %, 40 wt %, 45 wt %, 50 wt %, or any ranges therebetween, by total weight of said particulate detergent composition.

The major surfactant may be selected from the group consisting of a C₁₀-C₂₀ linear or branched alkylalkoxylated sulfate (AAS) surfactant; a C₆-C₂₀ linear or branched unalkoxylated alkyl sulfate (AS) surfactant; a C₁₀-C₂₀ linear alkyl benzene sulphonate (LAS) surfactant; a methyl ester fatty acid sulphonate (MES) surfactant; alkyl alkoxylated alcohols and combinations thereof.

The alkyl sulphate, alkyl alkoxylated sulphate and alkyl benzene sulphonates may be linear or branched, substituted or un-substituted, and may be derived from petrochemical material or biomaterial. Suitable alkyl benzene sulphonate (LAS) is obtainable, preferably obtained, by sulphonating commercially available linear alkyl benzene (LAB). Suitable LAB includes low 2-phenyl LAB and high 2-phenyl LAB, such as those supplied by Sasol under the tradename Hyblene®. Suitable sulphate detersive surfactants include alkyl sulphate, preferably C₈-C₁₈ alkyl sulphate, or predominantly C-12 alkyl sulphate.

Particularly, the major surfactant used in the detergent granule of the present invention may comprise a branched or linear unalkoxylated alkyl group containing from about 6 to about 18 carbon atoms, and is therefore also referred to as Mid-Cut AS or MCAS. Preferably, the AS has the generic formula of R—O—SO₃⁻ M⁺, while R is branched or linear unalkoxylated C₆-C₁₆ alkyl group, and M is a cation of alkali metal, alkaline earth metal or ammonium. More preferably, the R group of the AS surfactant contains from about 8 to about 16 carbon atoms, more preferably from about 10 to about 14 carbon atoms, most preferably from about 12 to about 14 carbon atoms. R can be substituted or unsubstituted, and is preferably unsubstituted. R is substantially free of any alkoxylation. M is preferably a cationic of sodium, potassium, or magnesium, and more preferably M is a sodium cation.

The amount of AS surfactant(s) present in the detergent granule of the present invention may range from about 50 wt % to about 95 wt %, and preferably from about 75 wt % to about 93 wt % by total weight of the detergent granule. With such a high level of AS surfactant(s), the detergent granule of the present invention exhibits a high detersive activity and a very good dissolution profile. In a most preferred embodiment of the present invention, the detergent granule contains from about 75 wt % to about 93 wt %, preferably from about 80 wt % to about 86 wt %, of an AS mixture consisting essentially of from about 70 wt % to about 80 wt % of C₁₂ AS and from 20 wt % to about 30 wt % of C₁₄ AS.

### Co-Surfactant

The co-surfactant in the detergent granule described in the present invention can be either a betaine having formula (I),

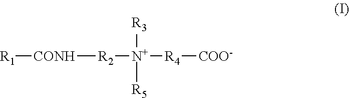

wherein R₁ is a linear alkyl group containing from 8 to 22 carbon atoms; R₂ is an alkylene group containing from 2 to 5 carbon atoms, and preferably an ethylene or propylene group; R₃ and R₅ are independently alkyl groups containing from 1 to 5 carbon atoms, and preferably methyl or ethyl groups; R₄ is an alkylene group containing from 1 to 3 carbon atoms, and preferably a methylene or ethylene group;
or a sultaine having formula (II),

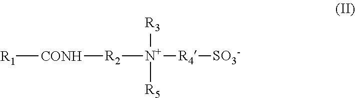

wherein R₁ is a linear alkyl group containing from 8 to 22 carbon atoms; R₂ is an alkylene group containing from 2 to 5 carbon atoms, and preferably an ethylene or propylene group; R₃ and R₅ are independently alkyl groups containing from 1 to 5 carbon atoms, and preferably methyl or ethyl groups; R₄′ is an alkylene or hydroxyl alkylene group containing from 1 to 3 carbon atoms, and preferably a methylene, ethylene or hydroxypropylene (CH₂CHOHCH₂) group.

Preferably, the co-surfactant can be a betaine or a sultaine selected from the group consisting of: almondamidopropyl betaine, apricotamidopropyl betaine, avocadamidopropyl betaine, babassuamidopropyl betaine, behenamidopropyl betaine, canolamidopropyl betaine, capryl/capramidopropyl betaine, cocoamidopropyl betaine, coco/oleamidopropyl betaine, coco/sunfloweramidopropyl betaine, cupuassuamidopropyl betaine, isostearamidopropyl betaine, lauramidopropyl betaine, meadowfoamamidopropyl betaine, milkamidopropyl betaine, minkamidopropyl betaine, myristamidopropyl betaine, oatamidopropyl betaine, oleamidopropyl betaine, olivamidopropyl betaine, palmamidopropyl betaine, palmitamidopropyl betaine, palm kernelamidopropyl betaine, ricinoleamidopropyl betaine, sesamidopropyl betaine, shea butteramidopropyl betaine, soyamidopropyl betaine, stearamidopropyl betaine, tallowamidopropyl betaine, undecyleneamidopropyl betaine, wheat germamidopropyl betaine, cocamidopropyl hydroxysultaine (CAPHS), lauramidopropyl hydroxysultaine (LAPHS), oleamidopropyl hydroxysultaine (OAPHS), tallowamidopropyl hydroxysultaine (TAPHS), and combinations thereof; preferably selected from the group consisting of cocoamidopropyl betaine, lauramidopropyl betaine, oleamidopropyl betaine, tallowamidopropyl betaine, cocamidopropyl hydroxysultaine, and combinations thereof; and more preferably, selected from cocoamidopropyl betaine, lauramidopropyl betaine, or a combination thereof.

### Water-Soluble Inorganic Salt

The detergent granule described in the present invention further comprises 0.5% to 20% of water-soluble inorganic salt as a filler.

The addition of water-soluble salt may help to improve flowability of the particle, thus make it easy to handle during storage, shipping and manufacturing. On the other hand, if the detergent granule contains too high amount of the water-soluble inorganic salt, the amount of surfactants in such detergent granule likely must be reduced, which is undesirable. The water-soluble salt used in the detergent granule of the present invention can be selected from the group consisting of sodium sulfate, sodium carbonate, sodium chloride, magnesium chloride, magnesium sulfate, sodium silicate, and combinations thereof. Preferably, the water-soluble salt is selected from sodium sulfate, sodium chloride, sodium carbonate, or a combination thereof.

The amount of water-soluble salt present in the detergent granule of the present invention may range from about 0.5 wt % to about 70 wt %, for example, 5 wt %, 10 wt %, 20 wt %, 30 wt %, 40 wt %, 50 wt %, 60 wt %, 70 wt % or any ranges therebetween.

### Water Content

The detergent granule of the present invention may contain from about 1 wt % to about 5 wt % of water, preferably from about 1.5 wt % to about 4 wt %, more preferably from about 2 wt % to about 3 wt %. Too much water in the detergent granule may adversely affect its flowability and handability.

### Other Ingredients

The detergent granule of the present invention may contain one or more other ingredients, such as nonionic surfactants, bleach actives, enzymes, perfumes, polymers, chelants, brighteners, hueing dyes, colorants, dye transfer inhibitors, dye fixative agents, silicones, fabric softening agents (such as clay), flocculants (such as polyethyleneoxide), suds suppressors, or any combinations thereof. The detergent granules may further comprise alkalinity agents such as NaOH.

Suitable non-ionic surfactants are selected from the group consisting of: C8-C18 alkyl ethoxylates (such as NEODOL® non-ionic surfactants from Shell); C6-C12 alkyl phenol alkoxylates wherein preferably the alkoxylate units are ethyleneoxy units, propyleneoxy units or a mixture thereof; C12-C18 alcohol and C6-C12 alkyl phenol condensates with ethylene oxide/propylene oxide block polymers (such as Pluronic® from BASF); alkylpolysaccharides, preferably alkylpolyglycosides; methyl ester ethoxylates; polyhydroxy fatty acid amides; ether capped poly(oxyalkylated) alcohol surfactants; and mixtures thereof.

Preferred non-ionic detersive surfactants are alkyl polyglucosides and/or alkyl alkoxylated alcohols. The alkyl alkoxylated alcohols are preferably C8-C18 alkyl alkoxylated alcohols with an average degree of alkoxylation of from 1 to 50, preferably from 1 to 30, or from 1 to 20, or from 1 to 10. More preferably, the alkyl alkoxylated alcohols are C8-C18 alkyl ethoxylated alcohols having an average degree of ethoxylation of from 1 to 10, preferably from 1 to 7, more preferably from 1 to 5, and most preferably from 3 to 7. The alkyl alkoxylated alcohol can be linear, branched, and substituted or un-substituted. Suitable nonionic surfactants also include those sold under the tradename Lutensol® from BASF.

Suitable bleach actives of the present invention may include sources of hydrogen peroxide, bleach activators (such as tetra acetyl ethylene diamine and/or alkyl oxybenzene sulphonate), bleach catalysts (such as oxaziridinium bleach catalysts, transition metal bleach catalysts, especially manganese and iron bleach catalysts), pre-formed peracids (such as phthalimidoperoxycaproic acid), and photobleach (such as zinc and/or aluminium sulphonated phthalocyanine). A particularly suitable bleach includes a combination of a source of hydrogen peroxide with a bleach activator and/or a bleach catalyst.

Suitable enzymes may be selected from the group consisting of proteases, amylases, cellulases, lipases, bleaching enzymes (such as peroxidases/oxidases), pectate lyases, which include those of plant, bacterial or fungal origin and variants thereof.

Suitable polymers may be selected from the group consisting of carboxylate polymers, soil release polymer, anti-redeposition polymers, cellulosic polymers and care polymers.

A preferred polymer is a carboxylate polymer, more preferably a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers. It may be preferred that the carboxylate polymer has a weight average molecular weight of at least 30 kDa, or at least 50 kDa, or even at least 70 kDa. Preferred carboxylate polymers include: polyacrylate homopolymers having a molecular weight of from 4,000 Da to 9,000 Da; maleate/acrylate random copolymers having a molecular weight of from 30,000 to 100,000 Da, or from 50,000 Da to 100,000 Da, or from 60,000 Da to 80,000 Da.

Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Suitable anti-redeposition polymers include polyethylene glycol polymers and/or polyethyleneimine polymers. Suitable polyethylene glycol polymers include random graft co-polymers comprising: (i) hydrophilic backbone comprising polyethylene glycol; and (ii) hydrophobic side chain(s) selected from the group consisting of: C4-C25 alkyl group, polypropylene, polybutylene, vinyl ester of a saturated C1-C6 mono-carboxylic acid, C1-C6 alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan HP22.

Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof. Suitable carboxymethyl celluloses have a degree of carboxymethyl substitution from 0.5 to 0.9 and a molecular weight from 100,000 Da to 300,000 Da. Suitable carboxymethyl celluloses have a degree of substitution greater than 0.65 and a degree of blockiness greater than 0.45.

Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose. Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis). Other suitable care polymers include amino-silicone, which can provide fabric feel benefits and fabric shape retention benefits.

Suitable chelants are selected from: diethylene triamine pentaacetate (DTPA), diethylene triamine penta(methyl phosphonic acid), ethylene diamine-N′N′-disuccinic acid (EDDS), ethylene diamine tetraacetate (EDTA), ethylene diamine tetra(methylene phosphonic acid), hydroxyethane diphosphonic acid (HEDP), hydroxyethane di(methylene phosphonic acid), NTA, MGDA, GLDA and the like. A preferred chelant is EDDS and/or GLDA and/or MGDA. The composition preferably comprises EDDS or salt thereof. Preferably the EDDS is in S,S enantiomeric form. Preferably the composition comprises 4,5-dihydroxy-m-benzenedisulfonic acid disodium salt. Preferred chelants may also function as calcium carbonate crystal growth inhibitors such as: HEDP and salt thereof; N,N-dicarboxymethyl-2-aminopentane-1,5-dioic acid and salt thereof; 2-phosphonobutane-1,2,4-tricarboxylic acid and salt thereof, and combination thereof.

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13, Liquitant V200, Liquitant E4210 and any combination thereof.

Suitable brighteners include for example, stilbene, pyrazoline, coumarin, carboxylic acid, methinecyanines, dibenzothiophene-5-dioxide, azoles, derivatives of 5- and 6-membered heterocyclic compounds, and the like. Particularly preferable examples thereof include biphenyl-type optical brighteners such as 4,4′-bis (2-sulfostyryl) biphenyl disodium salt and 4,4′-bis-(4-chloro-3-sulfostyryl)-biphenyl disodium salt; 4,4′-bis ((4-amino-6-morpholino-1, Stilbene-type optical brighteners such as 3,5-triazinyl-2) amino) stilbene-2,2′-disulfonate and 4,4′-bis ((4-toluidino-6-morpholino-1,3,5-triazinyl-2) amino) stilbene-2,2′-disulfonate. Preferred commercially available brighteners include C.I. Florescent brightener 260 and 351, as well as OBA 185 (Megawhite).

Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

Suitable perfumes comprise perfume materials selected from the group: (a) perfume materials having a Clog P of less than 3.0 and a boiling point of less than 250° C. (quadrant 1 perfume materials); (b) perfume materials having a Clog P of less than 3.0 and a boiling point of 250° C. or greater (quadrant 2 perfume materials); (c) perfume materials having a Clog P of 3.0 or greater and a boiling point of less than 250° C. (quadrant 3 perfume materials); (d) perfume materials having a Clog P of 3.0 or greater and a boiling point of 250° C. or greater (quadrant 4 perfume materials); and (e) mixtures thereof. It may be preferred for the perfume to be in the form of a perfume delivery technology. Such delivery technologies further stabilize and enhance the deposition and release of perfume materials. Such perfume delivery technologies can also be used to further increase the longevity of perfume. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof.

Suitable silicones include polydimethylsiloxane and amino-silicones.

### Solid Detergent Composition

The solid detergent composition of the present invention is a fully formulated, free-flowing particulate detergent composition comprising the detergent granules mentioned hereinabove. Typically, the solid detergent composition comprises the above-mentioned detergent granules, either without any other particles or in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

### Method of Use

The cleaning composition is typically used for cleaning and/or treating a situs inter alia a surface or fabric. As used herein, “surface” may include such surfaces such as dishes, glasses, and other cooking surfaces, hard surfaces, hair or skin. Such method includes the steps of contacting an embodiment of the cleaning composition, in neat form or diluted in a wash liquor, with at least a portion of a surface or fabric, then optionally rinsing such surface or fabric. The surface or fabric may be subjected to a washing step prior to the aforementioned rinsing step. For purposes of the present invention, “washing” includes but is not limited to, scrubbing, wiping, and mechanical agitation.

The composition solution pH is chosen to be the most complimentary to a target surface to be cleaned spanning broad range of pH, from about 5 to about 11. For personal care such as skin and hair cleaning pH of such composition preferably has a pH from about 5 to about 8, and for laundry cleaning compositions pH of from about 8 to about 10. The compositions are preferably employed at concentrations of from about 200 ppm to about 10,000 ppm in solution. The water temperatures preferably range from about 5° C. to about 100° C.

In one aspect, a method of laundering fabrics using the cleaning composition of the present invention is disclosed. The method may comprise the steps of contacting a fabric to be laundered with the cleaning composition or a wash liquor formed thereby. The fabric may comprise most any fabric capable of being laundered in normal consumer use conditions.

The cleaning composition herein is especially well-suited for use in a hand-washing context. It can also be used in automatic mashing washing using a top-loading or front-loading automatic washing machine.

The cleaning composition may be employed at concentrations of from about 500 ppm to about 15,000 ppm in solution, and optionally, more dilute wash conditions can be used. Optionally, 50 g or less, or 45 g or less, or 40 g or less, or 35 g or less, or 30 g or less, or 25 g or less, or 20 g or less, or even 15 g or less, or even 10 g or less of the cleaning composition is dissolved into water to form a wash liquor. The wash liquor preferably has a pH of from about 8 to about 10.5. The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water. For dilute wash conditions, the wash liquor may comprise 150 litres or less of water, 100 litres or less of water, 60 litres or less of water, or 50 litres or less of water, especially for hand washing conditions, and can depend on the number of rinses. The water to fabric ratio is typically from about 1:1 to about 30:1. Typically, from 0.01 Kg to 2 Kg of fabric per litre of wash liquor is dosed into the wash liquor.

It is preferable that the cleaning composition can be used in hard water conditions where the water hardness is between about 17 ppm to about 600 ppm; or from about 34 ppm to about 340 ppm; or from about 51 ppm to about 300 ppm of hard water ions such as Ca²⁺, Mg⁺, etc., or such as Ca²⁺ and Mg²⁺. It is also preferable that the cleaning composition can be used in cold water temperature, where the temperature is from about 5° C. to about 40° C., or from about 20° C. to about 30° C., or from about 15° C. to about 25° C., as well as all other combinations within the range of about 15° C. to about 35° C., and all ranges within 10° C. to 40° C.

### Test Methods

The following techniques must be used to determine the properties of the detergent granules and detergent compositions of the invention in order that the invention described and claimed herein may be fully understood.

### Test 1: Particle Size Distribution Test

The particle size distribution is measured by Malvern Mastersizer 2000, dry particles (e.g. PCC) is dispersed in water with around 15% obscuration, which is a dynamic laser diffraction technology.

All particulate samples are measured using the following measurement parameters:
Refractive index: 1.6;
Absorption: 0.1;
Result model: general purpose with normal and irregular option selected;
Measurement cycles per sample: 60;
Sample measurement time per cycle: 1 min;
Background measurement time: 2 min;
Obscuration filtering: off; and
Alarms: off.

Each sample is loaded into the Scirocco and then fitted with the general-purpose tray. The Scirocco is equipped with the fine mesh screen and approximately 20 to 25 flow dispersion spheres. The sample is then fed through the Mastersizer using a feeding air pressure of 3.5 bar and the vibratory feed rate is adjusted to give laser obscuration of 3 to 12%. After measurements, the results are recalculated to transform the volume-based distribution into a number-based distribution using the Result Transformation function in the Malvern software. When using the Result Transformation function, it is important to remember that the fundamental parameter which is measured is volume. Transformations to number or length should be treated with caution, particularly if:
1) The material measured shows a significant proportion (>15%) of sub-micron material.
2) If there is an unmeasured proportion of the distribution, as any errors are cubed when transforming to a number distribution.

### Test 2: Cleaning Performance Technical Test

In order to determine cleaning performance, a test method is conducted as below:
1, Provide stained fabrics, for example fabrics stained by a stain which is selected from the group consisting of Banco+Lard, Beef, Burnt Butter, Oil+Chicken, Oil+Fish, Grass, PCS 132 (sebum), PCS 94 (sebum+dust). Fabrics are stained by adding appropriate amount of the stain (e.g., 0.3 to 1 ml) with a pipette.
2. Use a color (RGB) video camera or digital still camera to take a photo of the fabrics to measure the L, A, B value before wash.
3, Dissolve the powder detergent composition under hand wash conditions (around 4000 ppm into RO water with 4 gpg hardness solution (Ca:Mg=4:1) and HMI (Fe/Mn/Cu=0.09/0.04/−ppm) solution, 27-29° C.) for 3 minute. Soak the stained fabrics in water containing the powder detergent composition for 60 minutes.
5, Place all stained fabrics in a washing machine and start machine washing. The main wash time is 20 minutes. The rinse time is 3 minutes. Rinse 2 times.
6, Remove the fabrics from the washing machine and line dry.
7, Use a color (RGB) video camera or digital still camera to take a photo of the fabrics to measure L,A,B value after wash.
8, To calculate ΔE and SRI by using L,A,B value before and after wash. The values of ΔE and SRI (Soil Removal Index) are determined as follows:

$$Δ {E}_{A B} = \sqrt{{( {L}_{A} - {L}_{B} )}^{2} + {( {a}_{A} - {a}_{B} )}^{2} + {( {b}_{A} - {b}_{B} )}^{2}}$$

$$Δ {E}_{AD} = \sqrt{{( {L}_{A} - {L}_{D} )}^{2} + {( {a}_{A} - {a}_{D} )}^{2} + {( {b}_{A} - {b}_{D} )}^{2}}$$

$$SRI = 100 ⋆ ( Δ {E}_{AB} - Δ {E}_{A D} ) / Δ {E}_{A B}$$

Note: A and B are respectively a clean point and a stained point in the initial fabric (i.e., before wash); C and D are respectively a clean point and a stained point in the washed fabric.

### Test 3: Cleaning Performance Consumer Test

A cleaning performance consumer test is carried out for characterizing the cleaning performance from a consumer POV. Particularly, samples of solid detergent compositions (Test sample and Reference sample) are prepared. Then, dirty fabrics are washed in a blind test by the following steps:
1. Add Load and Samples in the washing machine (30 C temperature, 800 rpm)
2. Wash for 30 minutes
3. Rinse for 10 minutes.
4. Repeat 4 cycles

Then, a panel of 15 people grades various aspects of the cleaning performance for samples including Test samples and Reference samples at a 100-point scale. A higher score means a better performance. The scores for each sample are obtained by calculating the average score of 15 people.

| Cleaning performance | Score |
|---|---|
| OAR (Overall Acceptance Rating) | 1-100 |
| RCR (Relative Consumer Rating) | 1-100 |
| Overall cleaning | 1-100 |
| Cleaning daily dirt/soil | 1-100 |
| Removing body soil from shirt collar, cuffs and underarms | 1-100 |
| Removing yellowness and dinginess | 1-100 |
| Removes tough stains like rust and blood | 1-100 |
| Provides superior whiteness | 1-100 |

### EXAMPLES

### Example 1: Comparative Cleaning Performance and Reduced Total Surfactant Content of Detergent Composition Containing Betaine Vs. Detergent Composition without Betaine

Detergent granules with the composition as shown in Table 1 below were made by a conventional making process. Typically, a suitable making process comprises the step of preheating a major surfactant paste, then adding a co-surfactant and an inorganic salt into the paste in a mixer, and finally drying the paste to provide detergent granules. Next, such detergent granules can be mixed with other ingredients to provide a particulate detergent composition. Particularly, Samples 1, 3 and 5 do not comprise betaine while Samples 2, 4 and 6 comprise betaine as a co-surfactant and has a reduced amount of total surfactant.

TABLE 1

| | Sample | Sample | Sample | Sample | Sample | Sample |
|---|---|---|---|---|---|---|
| Ingredients (wt %) | 1 | 2 | 3 | 4 | 5 | 6 |
| Linear alkyl benzene | 17.3% | 17.3% | 17.7% | 17.7% | 17.3% | 17.3% |
| sulphonate (LAS) | | | | | | |
| Alkyl sulfate (AS) | 9.3% | 6.3% | 5.8% | 3.9% | 9.3% | 6.2% |
| Cocamidopropyl | — | 0.2% | — | 0.1% | — | 0.2% |
| betaine | | | | | | |
| Na₂CO₃ | 23.0% | 23.0% | 24.7% | 24.7% | 23.0% | 23.0% |
| Na₂SO₄ | 22.6% | 22.6% | 25.2% | 25.2% | 25.6% | 28.5% |
| CaCO₃ | 4.1% | 4.1% | 4.3% | 4.3% | 4.1% | 4.1% |
| NaCl | 15.2% | 15.2% | 11.7% | 11.7% | 15.2% | 15.2% |
| Zeolite | 0.9% | 0.9% | 1.0% | 1.0% | 0.9% | 0.9% |
| Enzyme | 0.25% | 0.25% | 0.42% | 0.42% | 0.1% | 0.1% |
| Percarbonate | 1.7% | 1.7% | 3.7% | 3.7% | — | — |
| TAED | 0.25% | 0.25% | 0.4% | 0.4% | — | — |
| Perfume | — | — | — | — | 1% | 1% |
| Miscellaneous | Balance | Balance | Balance | Balance | Balance | Balance |
| Total surfactant | 26.6% | 23.8% | 23.5% | 21.7% | 26.6% | 23.7% |

The cleaning performance of these detergent composition samples were tested in accordance with Test 2: Cleaning Performance Technical Test. A positive Delta SRI of test samples means a better soil removal compared to reference samples while a negative Delta SRI of test samples means a worse soil removal compared to reference samples. Surprisingly and unexpectedly, the results as shown below indicate the cleaning performance is overall parity between the detergent composition containing betaine as a co-surfactant but having a reduced total surfactant content and the detergent composition without betaine.

TABLE 2

| | Sample 1 | Sample 2 | Sample 3 | Sample 4 |
|---|---|---|---|---|
| | (Reference) | (Test) | (Reference) | (Test) |
| Total surfactants | 26.6% | 23.8% | 23.5% | 21.7% |
| Stains | SRI | Delta SRI | SRI | Delta SRI |
| Banco + Lard | 55.0 | 3.6 | 59.3 | 2.5 |
| Beef | 96.1 | 0.7 | 96.8 | 0.3 |
| Burnt Butter | 81.1 | 0.2 | 78.7 | 1.0 |
| Oil + Chicken | 77.2 | 1.6 | 76.3 | −0.5 |
| Oil + Fish | 83.6 | 1.2 | 83.3 | −0.4 |
| Grass | 92.9 | −0.1 | 93.0 | −0.4 |
| PCS 132 (sebum) | 56.8 | 0.5 | 57.4 | −0.8 |
| PCS 94 (sebum + | 71.8 | −0.6 | 72.8 | −3.5* |
| dust) | | | | |

*Not statistically significant in view of HSD being 3.80

Furthermore, in order to survey the cleaning performance of these detergent compositions from a consumer point of view, these samples were tested in accordance with Test 3: Cleaning Performance Consumer Test. Consistently, as shown in the table below, the detergent composition containing betaine as a co-surfactant but having a reduced total surfactant content shows a comparative cleaning performance or even better in some specific aspects compared to the detergent composition without betaine.

TABLE 3

| | Sample 5 | Sample 6 |
|---|---|---|
| | (Reference) | (Test) |
| OAR (Overall Acceptance Rating) | 65 | 73 |
| RCR (Relative Consumer Rating) | 72 | 72 |
| Overall cleaning | 61 | 68 |
| Cleaning daily dirt/soil | 62 | 69 |
| Removing body soil from shirt collar, | 63 | 65 |
| cuffs and underarms | | |
| Removing yellowness and dinginess | 52 | 64 |
| Removes tough stains like rust and blood | 48 | 55 |
| Provides superior whiteness | 65 | 62 |

### Example 2: Detergent Compositions

Examples A-E hereinafter illustrate particulate detergent compositions comprising betaine or sultaine as a co-surfactant.

TABLE 4

| | Wt % | | | | |
|---|---|---|---|---|---|
| Ingredients | A | B | C | D | E |
| LAS | 6 | 10 | 27 | 21.5 | 0-50 |
| AS | 15 | 7 | — | — | 0-20 |
| Methyl ester sulfonate (MES) | 2 | 6 | — | — | 0-10 |
| Soap | 0.8 | 0.1-11 | — | 2.7 | 0-15 |
| Nonionic surfactant | 0.8 | 1-3 | — | 2.5 | 0-5 |
| Cocamidopropyl Betaine | 0.1 | — | — | 0.05 | 0.4 |
| Palm Kernel Betaine | — | 0.2 | 0.4 | — | — |
| Na2CO3 | 13-25 | 4-20 | 9-30 | 8-42 | 0-50 |
| Na2SO4 | 25-40 | 30-60 | 20~50 | 0~60 | 0-60 |
| Protease | 0.1 | 0.5 | 0.07~1 | 0~1 | 1 |
| Cellulase | 0.12 | 0.32 | | | 1 |
| Mananase | 0.1 | 0.12 | | | 1 |
| Lipase | 0.05 | 0.08 | | | 1 |
| Brightener (C.I. fluorescent | 0-0.3 | 0-0.1 | 0-0.4 | 0-0.2 | 0-1 |
| brightener 260 or C.I. fluorescent | | | | | |
| brightener 351) | | | | | |
| Aesthetic particles | — | — | 0.5 | 1 | — |
| (speckles/rings/etc.) | | | | | |
| Hueing dyes | — | — | — | 0.1 | 0-1 |
| Percarbonate | — | — | 2.5 | 7.2 | — |
| Bleach activator (TAED/etc.) | — | — | 0.4 | 0.5 | — |
| Silicate | 8-17 | 0-11 | 0-5 | 0-20 | 0-30 |
| Carboxylate polymer (such as | 0-5 | 0-2.5 | 0~3.5 | 0.08~0.25 | 0-5 |
| polyacrylates or copolymers of | | | | | |
| maleic acid and acrylic acid) | | | | | |
| CMC or Blocky CMC | 0.1-0.3 | 0-0.6 | 0.1~0.5 | 0-1 | 0-1 |
| Chelant (e.g., DTPA, GLDA, | — | — | 0~0.2 | — | 0-1 |
| MGDA, EDDS, HEDP, etc.) | | | | | |
| Zeolite (as a builder, not flow aid) | 1.0-3.0 | 4-10 | 1.0~5.0 | — | 0-20 |
| Perfumes (e.g., SEA, sprayed-on | 0-1 | — | 0-1 | 0-1 | 0-1 |
| perfumes, perfume microcapsules, | | | | | |
| etc.) | | | | | |
| Silicone | — | — | 0-0.005 | — | 0-0.1 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A particulate detergent composition comprising a plurality of detergent granules, wherein said composition comprises:
(a) from 10 wt % to 60 wt %, by weight of the composition, of a major surfactant, and
(b) from 0.02 wt % to 0.45 wt %, by weight of the composition, of a co-surfactant,
wherein said major surfactant is selected from the group consisting of a C₁₀-C₂₀ linear or branched alkylalkoxylated sulfate (AAS) surfactant; a C₆-C₂₀ linear or branched unalkoxylated alkyl sulfate (AS) surfactant; a C₁₀-C₂₀ linear alkyl benzene sulphonate (LAS) surfactant; a methyl ester fatty acid sulphonate (MES) surfactant; alkyl alkoxylated alcohols and any combinations thereof,
wherein said co-surfactant is a betaine or a sultaine,
wherein the weight ratio of said major surfactant to said co-surfactant ranges from 20:1 to 2500:1.

2. The composition according to claim 1, wherein said major surfactant comprises C₁₀-C₁₈ linear or branched unalkoxylated alkyl sulfate (AS) surfactant and/or a C₁₂-C₁₈ linear alkyl benzene sulphonate (LAS) surfactant.

3. The composition according to claim 1, wherein said co-surfactant is selected from the group consisting of: almondamidopropyl betaine, apricotamidopropyl betaine, avocadamidopropyl betaine, babassuamidopropyl betaine, behenamidopropyl betaine, canolamidopropyl betaine, capryl/capramidopropyl betaine, cocoamidopropyl betaine, coco/oleamidopropyl betaine, coco/sunfloweramidopropyl betaine, cupuassuamidopropyl betaine, isostearamidopropyl betaine, lauramidopropyl betaine, meadowfoamamidopropyl betaine, milkamidopropyl betaine, minkamidopropyl betaine, myristamidopropyl betaine, oatamidopropyl betaine, oleamidopropyl betaine, olivamidopropyl betaine, palmamidopropyl betaine, palmitamidopropyl betaine, palm kernelamidopropyl betaine, ricinoleamidopropyl betaine, sesamidopropyl betaine, shea butteramidopropyl betaine, soyamidopropyl betaine, stearamidopropyl betaine, tallowamidopropyl betaine, undecyleneamidopropyl betaine, wheat germamidopropyl betaine, cocamidopropyl hydroxysultaine (CAPHS), lauramidopropyl hydroxysultaine (LAPHS), oleamidopropyl hydroxysultaine (OAPHS), tallowamidopropyl hydroxysultaine (TAPHS), and combinations thereof.

4. The composition according to claim 1, wherein said major surfactant is present at a level of from 15 wt % to 50 wt %, by total weight of said particulate detergent composition, and/or wherein said co-surfactant is present at a level of from 0.03 wt % to 0.4 wt %, by total weight of said particulate detergent composition, and/or wherein the weight ratio of said major surfactant to said co-surfactant ranges from 25:1 to 2000:1.

5. The composition according to claim 1, wherein said composition further comprises one or more filler salts.

6. The composition according to claim 1, wherein said composition further comprises alkali metal carbonate.

7. The composition according to claim 1, wherein said composition further comprises one or more ingredients selected from the group consisting of polymers, silicones, perfumes, nonionic surfactants, and combinations thereof.

8. The composition according to claim 1, wherein total surfactant content in the particulate detergent composition is from 10% to 80% by weight of the composition.

9. The composition according to claim 1, wherein the composition comprises:
(a) from 15 wt % to 20 wt %, by weight of the composition, of LAS; and/or
(b) from 4 wt % to 8 wt %, by weight of the composition, of AS; and/or
(c) from 0.05 wt % to 0.35 wt %, by weight of the composition, of cocoamidopropyl betaine; and/or
(d) from 0 wt % to 5 wt %, by weight of the composition, of zeolite builder; and/or
(e) from 5 wt % to 40 wt %, by weight of the composition, of sodium carbonate; and/or
(f) from 5 wt % to 40 wt %, by weight of the composition, of sodium sulfate; and/or
(g) from 0 wt % to 5 wt %, by weight of the composition, of silicate; and/or
(h) from 0 wt % to 5 wt % by weight of the composition, of a brightener.

10. The composition according to claim 1, wherein said detergent composition is in a form of an agglomerate, a spray-dried powder, and/or an extruded powder.

11. The composition according to claim 1, wherein said detergent composition is a laundry detergent composition.

12. A method of making detergent granules, wherein the detergent granules comprise: a major surfactant; and a co-surfactant,
wherein said major surfactant is selected from the group consisting of a C₁₀-C₂₀ linear or branched alkylalkoxylated sulfate (AAS) surfactant; a C₆-C₂₀ linear or branched unalkoxylated alkyl sulfate (AS) surfactant; a C₁₀-C₂₀ linear alkyl benzene sulphonate (LAS) surfactant; a methyl ester fatty acid sulphonate (MES) surfactant; alkyl alkoxylated alcohols and any combinations thereof,
wherein said co-surfactant is a betaine or a sultaine,
wherein the weight ratio of said major surfactant to said co-surfactant ranges from 20:1 to 2500:1,
wherein the method comprises the steps in sequence:
A1) mixing the major surfactant and the co-surfactant to form a mixed paste, and
A2) drying the mixed paste to form the detergent granules, or
B1) drying the major surfactant to form major surfactant particles and drying the co-surfactant to form co-surfactant particles, respectively, and
B2) mixing the major surfactant particles and the co-surfactant particles to form the detergent granules.

13. The method according to claim 12, wherein the mixed paste further comprises a water-soluble inorganic salt.
